(19) United States
(12) Patent Application Publication
(10) Pub. No.: US 2009/0043663 A1
(43) Pub. Date: Feb. 12, 2009

(54) Banking Account and Transaction Methods

(76) Inventor: Daniel N. Prater, Indianapolis, IN (US)

Correspondence Address: Bruce J. Bowman;Bowman & Associates, Suite 106, 1016 3rd Ave. SW, Carmel, IN, 46032, US

(21) Appl. No.: 12/187,611

(22) Filed: Aug. 7, 2008

Related U.S. Application Data
(60) Provisional application No. 60/954,363, filed on Aug. 7, 2007.

(51) Int. Cl. G06Q 40/00; G06Q 20/00; G06Q 10/00

(52) U.S. Cl. 705/16; 705/44; 705/30; 705/33

(57) ABSTRACT

A transaction account, system and method for combining a debit card with a credit card. The method provides for executing a transaction, including the steps of: maintaining a financial account associated with a transaction device for the execution of purchases, the account having a credit limit and an account balance indicative of an aggregate sum of previously authorized debits and credits; a periodic or intermittent source of funding to the account; receiving a request for authorization for a new transaction amount against the account in exchange for goods or services; and authorizing the requested transaction amount when the sum of the credit limit and the account balance exceeds the transaction amount. The proposed methods additionally may incorporate methods for the reporting of the account balance aggregate sum of debits and credits to the account holder. Methods involved in operatively administering the aggregate sum of debits and credits account balance will typically be hidden from the account holder resulting in the account holder having the experience of holding a single account capable of carrying both positive and negative balances, wherein negative balances may be charged interest, and positive balances may result in the accumulation of interest payments to the account from the issuer.

### RELATED APPLICATIONS

This patent application claims the benefit of and/or priority to U.S. Provisional Patent Application Ser. No. 60/954,363 filed Aug. 7, 2007, entitled “Banking Account and Transaction Methods” the entire contents of which is specifically incorporated herein by this reference.

### BACKGROUND OF THE INVENTION

1. Field of the Invention

The present invention relates to commercial transaction system processes and methods relating to credit accounts and debit accounts and, more particularly, to a commercial transaction system, process and method that combines the capabilities of a credit account and a debit account (“cash” account) into a single account that operates as a standard credit and/or debit account at the time of use.

2. Background Information

Credit cards have been around for quite some time wherein a card issuer advances funds to the credit card holder in order to allow the credit card holder to make purchases on credit. Such credit cards do not access a cash account of the credit card holder, but instead access a credit account having a pre-determined credit limit and a rate of interest that accrues to the credit card holder on any unpaid balance. The credit card issuer pays the merchant, who then bills the credit card holder for the transaction amount.

Debit cards are a more recent innovation in which a cash account is tied to the debit card. A debit card allows the user to access the cash account via an ATM or for purchases. The amount of available funds accessible by the debit card holder is limited by the cash account balance. Thus, the debit card holder is only able to obtain or spend the available cash amount in the debit card holder's cash account.

Because of disadvantages and/or limitations of prior art credit cards, debit cards and the like, various schemes have been proposed. For instances, U.S. Pat. No. 6,038,552 issued to Fleischl discloses a method and apparatus to process transactions employing a single credit card with the capabilities to withdraw from both credit and debit accounts. This prior art addresses the need for a multi-purpose credit card having the attributes of a standard credit card, a debit card, and an interest bearing cash account. The Fleischl system describes the withdrawal of funds for a purchase from a cash account when the amount of the purchase exceeds the credit limit of the credit account.

However, the Fleischl system is disadvantageous because the user must still maintain a running knowledge of the cash account and credit account balances in order to avoid penalties imposed by exceeding the credit limit of the credit account. Additionally, the credit account described in the Fleischl system must periodically be credited with funds in order to avoid penalties. The Fleischl system also does not reconcile the case wherein the balance of the credit account becomes zero, and the account holder now holds the account only in the case that the account holder needs to make a purchase in excess of the cash account balance. Critically, the Fleischl system differs from prior art transaction systems when the transaction amount exceeds the credit limit. In this case, the Fleischl system allows the transaction if the account holder has a cash balance available to be transferred to the credit card account at the time of the transaction when the credit limit would otherwise be exceeded by the transaction.

In U.S. Patent Publication 2007/0136194 by Sloan, there is described a program and method for administering a hybrid card program for extending and building credit. The Sloan system allows a single card, termed a “hybrid” card, to be used for both credit and debit transactions, the choice of transaction type being made by the account holder at the time of the transaction. The Sloan system describes linking typical cash or savings accounts to a credit account, the amount of the credit corresponding to an aggregate of credit purchases accumulated over a period, where the aggregate is secured by money in the cash or savings account.

The Sloan system is advantageous to account applicants with no, or poor, credit history. The Sloan system describes a system to issue credit to the account holder only when the amount of credit to be issued is available (and subsequently frozen or placed on hold) in the cash account. Thus the intended outcome is the reporting to credit-reporting agencies of on-time and full payments to the credit issuer. However, the Sloan system does not aid the creditworthy.

U.S. Patent Publication 2002/0116324 by Macias, describes a bank card that establishes an individual line of credit for the user and allows the user to define the circumstances when that line of credit will be tapped into. This enables the user to draw on liquid assets in checking or savings accounts before tapping into the line of credit. At the same time, the card enables the bank to increase profits by determining the risk for each customer individually and applying the appropriate interest rate. The Macias bank card is disadvantageous since the user may opt to leave funds in an account while tapping into the line of credit.

U.S. Patent Publication 2007/0271179 by Kubota describes a payment processing support device and method wherein a signature debit card transaction is processed as a credit card transaction when the debit card account contains insufficient funds to perform the transaction. However, the Kubota debit card is only a debit card when the amount in a corresponding cash account is sufficient to entirely cover the debit amount. If the amount in the corresponding account is not sufficient to entirely cover the debit amount, the entire transaction is treated as a credit card transaction.

U.S. Patent Publication 2008/0103970 by Books et al. describes a debit card loan system in which the debit card holder may access short-term loan. When coupled with deposit of the employees net pay into the financial account that is associated with the debit card by the card holder's employer, short-term loans provided to the card holder are automatically repaid when the employer makes a payroll deposit to the financial account that is associated with the debit card, or any time funds are deposited into the financial account. Short-term payday loans, however, are not the same as the extension of credit such as is associated with the typical credit card.

Given the above prior art and its shortcomings, it is apparent that there is a need for a banking transaction device, process and/or method that overcomes the drawbacks of the prior art.

### SUMMARY OF THE INVENTION

The present invention is a financial or bank/banking account, financial or banking transaction method and/or process that combine debit card attributes with credit card attributes. The account described herein is able to carry both negative balances and positive balances, thus merging the capabilities and advantages of both credit and debit accounts.

A central component of the present invention includes the processes and methods for maintaining an account comprising an aggregate sum of credits and debits where summing credits and debits includes the steps of: administering a system able to accommodate credits resulting in increasing net balance and debits resulting in decreasing net balance; issuing credit to the account applicant for use in the purchase of goods or services, the limit of that credit being subject to possible periodic adjustment as in current credit issuing systems; and maintaining an aggregate sum of withdrawals from and credits to a prior or beginning balance.

The present invention, in one form, provides a method for executing a transaction using a credit, debit or other type card or other transaction device (including the writing of a check) including the steps of: maintaining an account associated with the card or transaction device, the account having a credit limit and an account balance indicative of an aggregate sum of prior deposit minus prior debit amounts; receiving a request for authorization for a new transaction amount in exchange for goods or services; and authorizing the requested transaction when the requested transaction amount is exceeded by the aggregate sum of the credit limit and account balance.

The present invention in another form, provides processes and methods for executing a transaction using a transaction device (such as a credit/debit/smart card, check, cellular phone, or other device), where the apparatus includes: an account associated with the card or suitable other transaction device, the account having a credit limit and a transaction balance indicative of an aggregate sum of previously authorized transaction amounts; and a transaction execution processing unit coupled to the account, the transaction processing unit being adapted to (i) receive a request for authorization for a new transaction amount against the account in exchange for goods or services; and (ii) authorize the requested transaction amount when the sum of the account balance and available credit exceeds the requested transaction amount.

The methods and processes described herein differ by accounting an aggregate of credits and debits on an ongoing basis. The methods and processes described herein avoid many account holder inconveniences, and simplify the accounting of prior art credit account and debit account balances for the account holder. There is a need in the art for a single accounting system (or transaction system analogously employed for funds transfer and/or payments) and account maintenance processes which results in the user being able to access an aggregate account without the need for maintaining an ongoing knowledge of individual account balances. With the methods described herein, the holder of the combined credit and debit accounts will be able to withdraw funds using the same card (or similar applicable transaction device) whether the aggregate account balance is above zero, at zero, or below zero.

Additionally, the present invention addresses the need for the single account to employ all the benefit of traditional credit, debit, cash (for example checking accounts, debit card accounts, or ATM accounts), interest-earning (for example savings accounts, or equity accounts), related-art “hybrid”, stored-value (pre-paid), phone, and vendor-specific gift, cards (or devices) and accounts, into a single account which combines the benefits of all traditional, related art, and prior art account types.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a block diagram representation of major elements of a banking transaction system illustrating the relationship between various entities involved in transactions to banking and commerce and the incorporation of a combination credit/debit card and its associated banking transaction process in accordance with the principles of the present invention;

FIG. 2A is a flow chart illustrating one portion of a banking transaction process flow in accordance with the principles of the present invention;

FIG. 2B is a flow chart illustrating another portion of a banking transaction process flow in accordance with the principles of the present invention; and

FIG. 2C is a flow chart illustrating another portion of a banking transaction process flow in accordance with the principles of the present invention.

Like reference numerals indicate the same or similar parts throughout the several figures.

### DETAILED DESCRIPTION OF THE PREFERRED EMBODIMENT

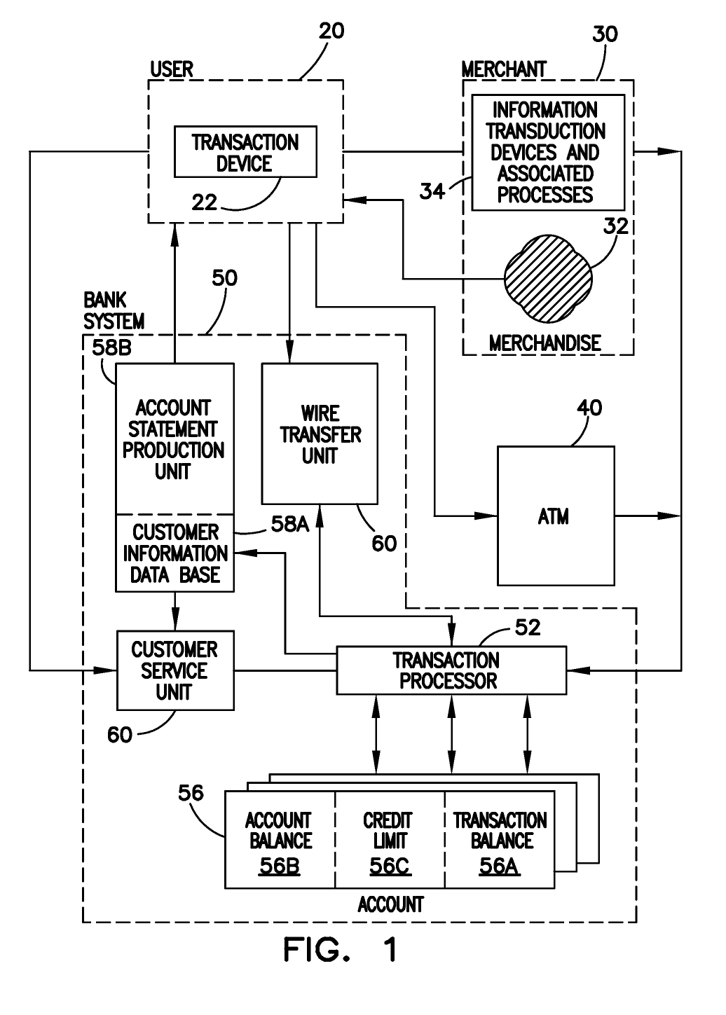

Referring to FIG. 1, there is illustrated a block diagram of the relationship between various entities involved in executing fund transactions in accordance with the principles of the present invention. The block diagram also shows the relationship between the various entities involved in using the present combines credit/debit card/account in accordance with the present principles.

The system consists of: one or more users 20, all considered as account holders for the sake of simplicity, with access to a transaction device 22 being a combined debit/credit card or similar functioning transaction device to participate in the process of funds transfer between entities (which may include a check for instances requiring the writing of a check, traditional credit card, traditional debit card, cellular phone transaction systems, and other transaction devices and associated processes utilizing advances in technique or technology); a merchant 30 capable of receiving the transaction device 22 in exchange for merchandise 32, with access to bank and transaction systems 50 for transaction information transfer; and bank and transaction systems 50 for authorizing a commercial transaction between the user 20 and the merchant 30. The system may also include an ATM 40 for permitting the user 20 to access cash, maintain the account including balance transfers, debt payment, bill payment, and all typical and common ATM transactions, with funds available to the account holder associated with the transaction device 22.

At the point in time that the user 20 and the merchant 30 agree to execute a transaction the user 20 presents or verifies access of the transaction device 22 to the merchant 30. The merchant then employs the information transduction devices and associated processes 34 in place for transaction information execution between the user 20, merchant 30, and the bank system 50. In one embodiment the transaction device 22 utilizes or is a member of common transaction devices such as MasterCard or Visa cards so that the goodwill and widespread infrastructure associated with those transaction systems permit the user 20, the merchant 30, and/or the bank and transaction system 50, the convenience of common and well-known transaction infrastructures. In the future, it is expected that the transaction system devices, processes, infrastructure, and account type described herein utilizes technological advances such as biometric or cell phone-mediated transaction devices 22, for example, with the proper corresponding information transduction device and associated processes 34. Likewise, it is expected that the account be able to accommodate standard transaction means available presently, such as check writing.

The merchant 30 employs an information transduction device and associated processes 34 to communicate with the bank system 50 utilizing communication mediums employed for such purposes. The bank system 50 includes: a transaction processor 52; an account 56 that may or may not be associated with the transaction device 22; a customer information data base 58A; a statement production unit 58B; and a customer service unit 60.

The transaction processor 52 is also operatively coupled to the merchant information transduction device and associated processes 34 in a way which is well known in the art such that the agreement to make a commercial transaction between the user 20 and the merchant 30 may be received by the transaction processor 52 of the bank system 50. The transaction processor 52 is operatively coupled to the account 56 in such a way that the transaction processor 52 may obtain the transaction amount 56A, account balance 56B, the credit limit 56C of the account 56, and credit or debit funds as per the request of the user 20, the merchant 30, and/or the ATM 40.

The account 56 may comprise discrete banking, accounting, or associated processes reflecting conventional or future account types, for example checking accounts, savings accounts (cash account that may or may not be interest-earning accounts), revolving debt accounts (as employed currently for credit card functionality, or as otherwise is or could be employed) pre-paid accounts, vendor-specific accounts, phone card accounts, and other account types not specifically mentioned, and any combination thereof, which participate in the operative function of the present invention. The account 56 may also be a single operative entity comprising a credit limit 56C and account balance 56B. The specific facilitation of the account 56 is left to the discretion of the bank system 50 or transaction processor 52 according to operative execution of the present invention methods and processes. In all cases, the account 56 may be considered a combined credit/debit account.

The transaction processor 52 of the bank system 50 is operatively coupled to the customer information data base 58A such that account holder information, for example, account holder name, account identifier or identifiers, contact information, credit history, and/or other details may be accessed and utilized in preparing an account summary or statement by the statement production unit 58B.

The customer service unit 60 of the bank system 50 is operatively coupled to the customer information data base 58A, the statement production unit 58B, and the transaction processor 52 to facilitate the normal, periodic, and occasional maintenance, reporting, and adjustment of the account 56, customer information data base 58A, and statement production unit 58B, including but not limited to: credit limit changes, finance charges, balance adjustments, penalty assessment, reassessment or removal, information updating, and other manipulations not specifically mentioned but commonly involved in the normal, periodic, and occasional maintenance of account holder information and account 56.

The bank system 50 typically comprises a wire transfer unit 62 (but which may exist outside of the bank system 50) which exists for the execution of funds transfer between entities common in banking and commerce. For example, wire transfer between separate banking systems 50 or between separate accounts 54 within a banking system 50, between account holder 20 and a separate bank system 30 such as that of an employer when depositing wages for example, and/or other entities not specifically mentioned but commonly involved in the normal, periodic, and occasional adjustment of the account balance 56B. These may include but are not limited to: the deposit or withdrawal of funds to or from the account 56 for payment of debt, deposits of funds from other individuals, businesses, and/or governmental entities, and/or from other entities or accounts not specifically mentioned but commonly involved in the normal, periodic, and occasional maintenance of banking accounts.

The account holder 20 may also decide to perform banking operations at an automatic teller machine (ATM) 40 which communicates either directly or indirectly to the bank system 50 through operative communication processes and methods. Such banking operations may include the withdrawal or deposit of cash or cash equivalents, the transfer of money or information equivalents between a transaction device (such as a credit card) 22 and the bank system 50 through the use of an ATM machine, the payment of debts to other entities (such as utility bills) via withdrawal from the account 56, and the transfer of money, equity, or information equivalents between the account 56 and other accounts (not shown) managed by other users or managed by the account holder 20.

FIG. 1 and corresponding descriptions described herein illustrate operations which are currently typical and common during the course of banking and commerce, and are included herein to illustrate functionality of the account 56. The diagrams and descriptions described herein include the operative flexibility to exploit novel or future baking features, devices, methods, and/or processes not explicitly mentioned herein.

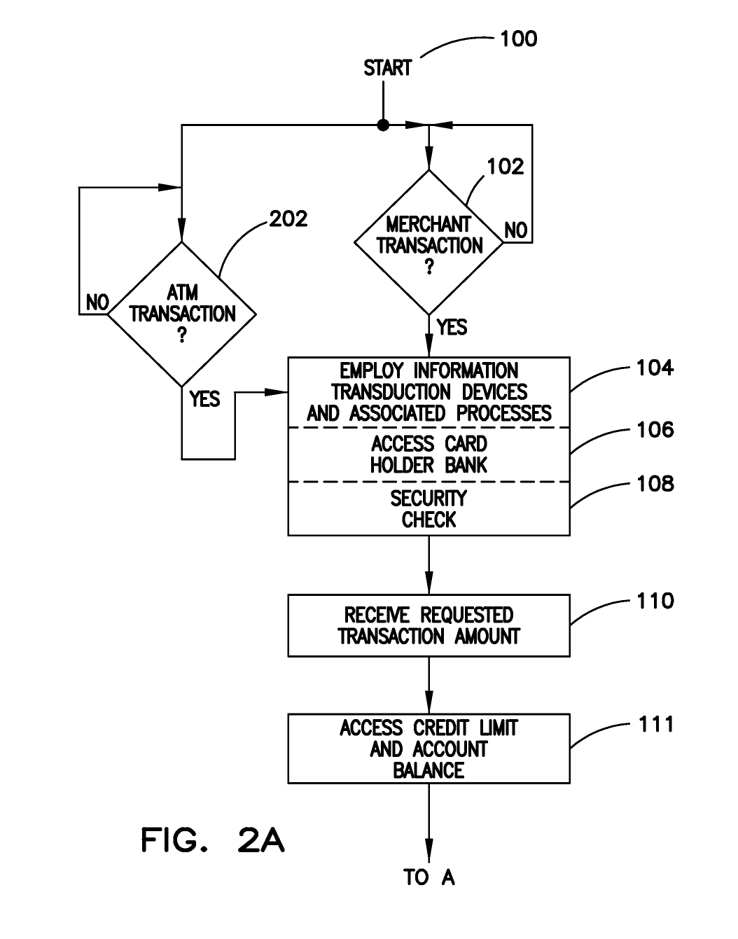

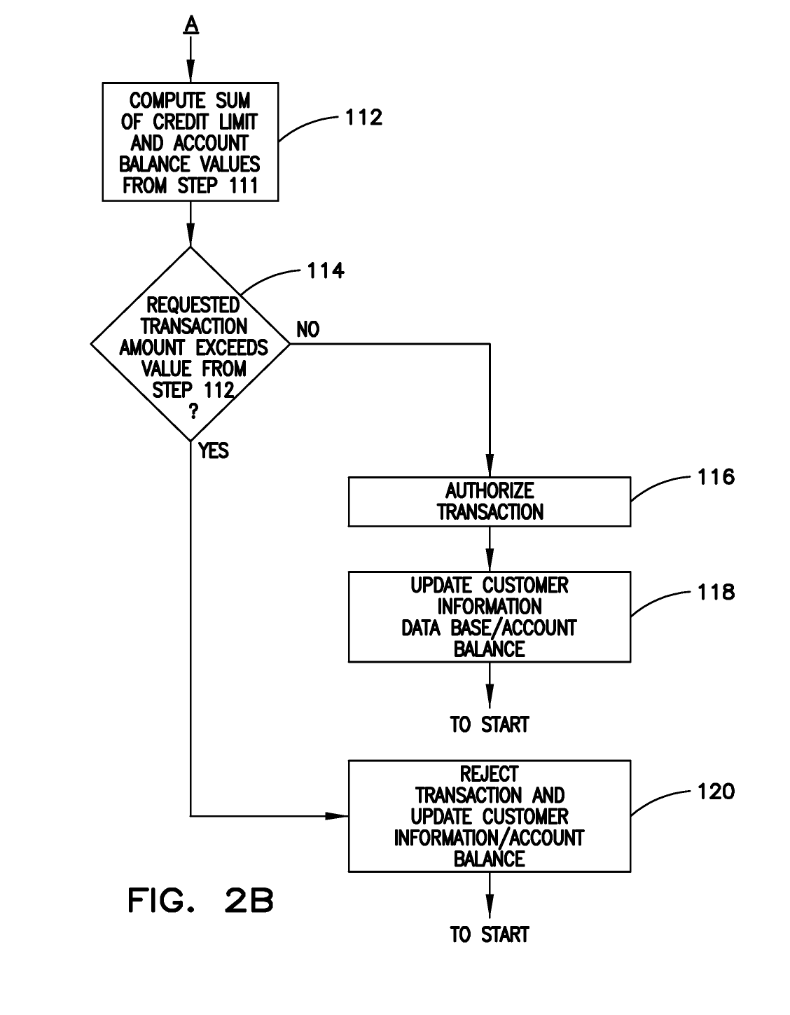

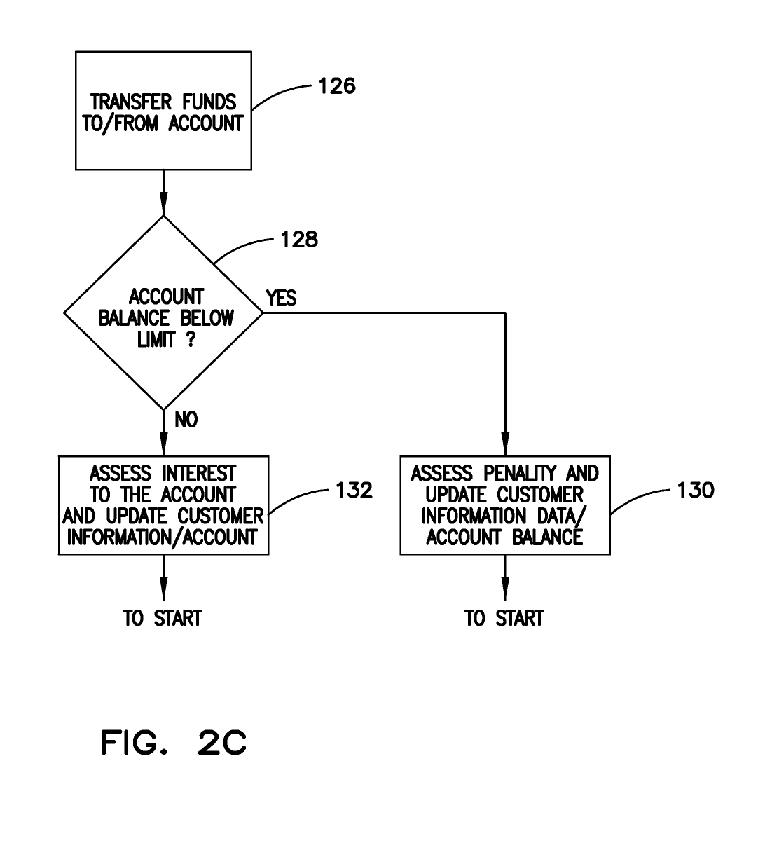

FIG. 2A illustrates a control and process flow diagram of a system fashioned in accordance with the present principles and which includes the system such as that illustrated in FIG. 1. FIG. 2A also defines a system flow for the present combination credit/debit card/account wherein the card/account holder uses the account (via a combined credit/debit card or the like) to access all available funds in the corresponding account and to create a credit account for purchases/withdrawals in excess of the available funds. At step 100, the account holder 20 presents to the merchant 30 a transaction device (i.e. the combined credit/debit card) 22 and, at step 102 the process flow will branch in the affirmative when the account holder 20 and the merchant 30 agree to execute a transaction.

At step 202, the account holder 20 employs an ATM (heretofore considered an information transduction device for the sake of describing ATM and merchant transaction processes simultaneously; differences in the transaction specifics will be familiar to those skilled in the art) for a cash withdrawal account maintenance including bill payment, funds transfer, and the like known to those familiar in the art. If an ATM transaction is initiated, the process flow then branches to step 104.

At step 104, the account holder 20 or the merchant 30 employs the information transduction device and associated processes 34, and information involved in the transaction is communicated either directly or indirectly to the bank system 50. Information is communicated between the transaction processor 52 of the bank system and either the information transduction device and associated processes 34, the merchant 30, or the user 20 (including the transaction device 22) at step 106. Communication links between the transaction processor 52 and the account holder 20 or transaction device 22 are not shown for diagrammatic simplicity but are included herein as processes and methods that may be utilized. At step 108 any of the known techniques for validating the identity of the merchant 30, account holder 20, and transaction information, is employed to generate confidence in a private, secure, valid, and trustworthy execution of the transaction. The specific techniques involved in the generation of said confidence in the transaction is left to the discretion of the bank system 50, transaction processor 52, communication systems (not shown), data manipulators (not shown), account holder 20, merchant 30, and any other operatively involved entity not explicitly mentioned herein, according to operative execution of the transaction and will be known to those skilled in the art.

At step 110 the transaction processor 52 receives the requested transaction amount via communication from the account holder 20 (communication path not shown), the merchant 30, or the information transduction device and processes 34 and stores information including the transaction amount/balance 56A in memory. At step 111 the transaction processor 52 retrieves information comprising the account balance 56B and the account credit limit 56C and stores those values in memory.

Referring now to FIG. 2B, at step 112 the transaction processor 52 then computes the sum of the account balance 56B and credit limit 56C and compares this sum to the transaction balance 56A and at step 114, either communicates permission for the transaction if the sum of the account balance 56B and credit limit 56C is greater than or equal to the transaction amount 56C, or rejects the transaction if the sum of the account balance 56B and credit limit 56C is less than the transaction amount 56A. Likewise, comparisons and computations may be performed in full or in part by the transaction device 22, the information transduction device and processes 34, or a separate device, entity or processor (not shown). Likewise, it may be preferable to incorporate a any or all of the bank system components into the transaction device system, including the transaction processor, memory for storage of the account balance 56B and credit limit 56C, account statement production unit 58B, customer data base 58A, etc. The architecture of the individual system components, processes, methods, and functions is left to the discretion of future advances in technology, techniques, methods, and processes. It may be possible that the bank system 50 be entirely incorporated into the transaction device 22.

The account balance 56B reflects an aggregate sum of credits and debits to the account 54 as the result of prior transactions, where credits and debits are computed as numbers of opposite sign. Specifically, the sum of the account balance 56B and credit limit 56C is computed regardless of the sign of the individual numbers reflecting the account balance 56B and credit limit 56C, but the sum is a result which is comparable to the transaction amount 56A in such a way as to allow the operative comparison of the sum and the transaction amount 56A. In one example of the present invention, credits to the account balance 56B are reflected as positive numbers and debits to the account balance 56B are reflected as negative numbers, facilitating the direct addition of credits and debits for the operative computation of the aggregate sum reflecting the account balance 54B as is common accounting for account balances. Additionally in this example, the credit limit of the account 56C is reflected as a positive number. Additionally in this example, the transaction amount 56A is reflected as a positive number which becomes a debit to the account balance 56B if the transaction is permitted. Thus in this example, at step 114, allowed transactions are those where the transaction amount 56A is less than the sum of the credit limit 56C and the sum of prior debits and credits reflected as the account balance 56B. Likewise, the transaction is rejected and penalties imposed if the transaction amount 56A is greater than the sum of the credit limit 56C and the account balance 56B.

Permutations of the computational processes described herein which result in either direct or indirect comparison of transaction balances, account balances, and credit limits, or reflections of these values thereof, are embodied by the descriptions herein. For example, the credit limit 56C may be considered a lower limit of the account balance 56B which may be negative if debits exceed credits to the account 56. In this example a transaction is allowed at step 114 if a debit to the account 56 of transaction amount 56A (plus any applicable fees) does not cause the aggregate balance of the account 56 to exceed the credit limit 56C, which represents the common comparison involved in prior art credit card transaction accounting. The comparison of account balance 56B, credit limit 56C, and transaction amount 56A at step 112 may thus be executed at any number of ways reflecting the aims of the present invention to unify account balance 56B and credit limit 56C.

In one embodiment of the present invention, if the transaction amount 56A exceeds the sum of the account balance 56B and credit limit 56C, the credit limit 56C may be increased to accommodate the sum of the transaction amount 56A and any penalty that is imposed for exceeding the predetermined credit limit 56C and the transaction is approved at step 114. In another embodiment of the present invention, if the transaction amount 56A is greater than the sum of the account balance 56B and the credit limit 56C, then the transaction is rejected at step 114 and a penalty is imposed to the account balance 56B. These exemplary embodiments represent features of credit accounts and checking (cash) accounts and are operative implementation of the present invention including the option of utilizing any of the features as necessary, desired, or appropriate.

Upon transaction approval the process flow branches to step 116 where the transaction is authorized. Communication is sent to the merchant 30, account holder 20, or ATM 40 of transaction authorization and the transaction is allowed to proceed with methods and processes as is common and known to those skilled in the art.

At step 118, the transaction processor 52 updates the account balance 56B according to the specifics of the transaction and updates the customer information data base 58A to reflect that a transaction has been executed. The customer information is used to prepare an account statement or summary for presentation to the user 20. The process flow then loops back to step 100 to await another transaction.

Upon transaction rejection at step 114 the process flow branches to step 120 where the transaction is rejected. The transaction processor 52 updates the account balance 56B to reflect any penalties and updates the customer information data base 58A to reflect that a transaction has been rejected. The customer information is used to prepare an account statement or summary for presentation to the user 20. The process flow then loops back to step 100 to await another transaction.

The present invention allows periodic payment (revealed as credits to the account balance 56B), automatic credit via employer direct deposit, intermittent, or gradual accumulation of funds as credits to the account balance 56B, to credit full payment to the account, partially credit the account, or the like. At step 126, the transaction processor 52 credits the account balance 56B the amount to be credited. Automatic crediting to the account, for example from employer direct deposit, is preferable as this avoids the incurring of late fees. Additionally, an advantage of the present invention is the ability to credit a negative account balance the amount of the automatic employer deposit resulting in the ability to achieve a positive account balance without the need to manually transfer funds as is the case in current banking methods.

Additionally at step 126, funds may be withdrawn or credited to the account via any other outside entity via operative communication means as is typical in banking. Such transactions may be wire transfers, cash deposits to the account at a typical bank teller or ATM outside of the system of the bank system 50, or other process common to present and/or future banking known to those skilled in the art.

At step 128, the transaction processor 52 determines whether the account balance 56B of the account 56 has fallen below a predetermined amount (typically zero). Comparison of account balance 56B and the predetermined amount may be done periodically or continuously.

When the account balance 56B has a value less then a predetermined amount (typically zero), the transaction processor 52 assesses a monetary penalty against the account balance 56B at step 130. Such penalty is common to be an interest rate, such as an annual percentage rate (APR) or annual percentage yield (APY) as is common for credit accounts such as credit card accounts. The penalty may also be a predetermined constant amount, fluctuating amount, and any combination thereof calculated and applied continuously, periodically, or intermittently. The processor 52 updates the customer information data base 58A to reflect the assessment. The updated customer information is used by the statement production unit 58B to prepare an account statement for the presentation to the user 20.

When the balance of the interest bearing account 56 has not fallen below the predetermined limit, the transaction processor 52 assesses (i.e. credits) interest to the account balance 56B at step 132. Such credit is common to be an interest rate, such as an annual percentage rate (APR) or annual percentage yield (APY) as is common for cash accounts such as savings accounts. The credit may also be a predetermined constant amount, fluctuating amount, and any combination thereof calculated and applied continuously, periodically, or intermittently. The processor 52 updates the customer information data base 58A to reflect the credit. The updated customer information is used by the statement production unit 58B to prepare an account statement for the presentation to the user 20.

Referring again to FIG. 1, at a point in time for account statement production, information regarding the account 56 including account balance 56B, credit limit 56C, transaction history, fees, penalties, interest earned, interest paid, customer information, and the like common to account statements as is known to those skilled in the art, is acquired and configured into an account statement or summary. The report preferably does not segregate transactions into credit and cash transactions as would be otherwise common in other systems, since the present invention unifies credit and cash transactions by unifying the account 56. Instead, the account holder would preferably be presented with the account balance 56B and the credit limit 56C. Also, the account holder may be presented with a value representing a “purchasing power”, consisting of the maximum transaction amount 56C allowable without penalty. This amount may be easily calculated as the credit limit 56C plus the account balance 56B representing the aggregate sum of credits and debits to the account. For example, if a credit limit of $2500 is granted to the account holder 20, and an aggregate sum of $500 has been credited to the account, while an aggregate sum of $1000 has been debited from the account by purchases and cash withdrawals, etc., the purchasing power would be $2500 plus $500 minus $1000, or $2000, and the account balance would be negative $500, and the holder will be responsible for accrual of any interest debited from the account. Conversely using similar numbers, if $1000 has been credited to the account, while an aggregate sum of $500 has been debited from the account, the purchasing power would be $2500 plus $1000 minus $500, or $3000, and the account balance would be positive $500, and the holder may be paid an amount in interest.

Additionally, ownership of the account may subject the account holder to fees such as annual fees, etc. and benefits such as purchase incentives (usage awards), insurance incentives, travel incentives, phone card capabilities, merchant-specific features, and the like known to those skilled in the art and common to cash accounts, savings (interest-earning) accounts, credit accounts (such as credit card accounts), pre-paid accounts, merchant-specific accounts, etc. The present invention assumes operative execution of the present invention may or may not include a plurality of incentives or penalties as deemed appropriate, sufficient, or necessary. Operative administration of these features is left to the discretion of the account holder, banking system, and/or any involved entity.

In all cases, the present invention provides a combined financial or banking credit/debit card and/or financial account that allows the user to access all of the funds within the account for withdrawal and/or purchases with any negative fund balance being provided to the user as credit against future funds allocated to the account. In this manner, credit is extended to the user to make up any difference in fund balance between the funds available and funds needed to complete the cash withdrawal or purchase. Interest is calculated on the credit extended. When funds deposited in the corresponding financial account exceed the credit given and interest accrued or charged, the card/account becomes a debit card/account up to the available funds.

While the invention has been illustrated and described in detail in the drawings and foregoing description, the same is to be considered as illustrative and not restrictive in character, it being understood that preferred embodiments have been shown and described and that all changes and modifications that come within the spirit of the invention are desired to be protected.

What is claimed is:

1. A method of implementing a financial account and executing transactions related to the financial account, the method comprising the steps of:
maintaining a financial account, the financial account having a credit limit and an account balance reflecting an aggregate sum of previously authorized transactions and adjustments;
receiving a request for authorization of a new transaction amount;
authorizing the new transaction amount as 1) a debit transaction against a positive account balance, and 2) as a credit transaction for any remaining amount less than a zero account balance; and
processing the requested transaction for a new transaction including updating and altering the account balance.

2. The method of claim 1, wherein the transaction comprises one of a cash deposit, direct deposit, check deposit, a point-of-sale merchant transaction, internet commerce transaction, an ATM transaction, and a wire transfer.

3. The method of claim 1, wherein the transaction device comprises a known credit/debit card issuer type transduction device and its associated processes.

4. The method of claim 3, wherein the transaction device comprises one of a magnetic card, smart card, cell phone and biometric card.

5. The method of claim 1, wherein the step of receiving a request for authorization of a new transaction amount from the transaction device comprises utilizing a financial system.

6. The method of claim 1, being administered by a financial institution.

7. The method of claim 1, further comprising the steps of:
calculating the sum of the account credit limit and account balance; and
comparing the sum to a debit transaction amount to return an authorization result.

8. The method of claim 7, wherein the authorization result comprises one of authorization allowance and authorization rejection.

9. The method of claim 1, further comprising the steps of:
calculating an amount of interest due on any negative account balance; and
applying the calculated amount of interest due to the financial account.

10. The method of claim 1, further comprising the step of adjusting the credit limit.

11. An apparatus for executing a financial transaction using a transaction device, the apparatus comprising:
a financial account associated with the transaction device, the account having a credit limit and a transaction balance indicative of an aggregate sum of previous transaction amounts; and
a transaction processing unit associated with the financial account, the transaction processing unit (i) receiving a request for authorization for a new transaction amount against the account in exchange for goods or services, and (ii) authorizing the requested transaction amount when the sum of the credit limit and account balance exceed the transaction amount.

12. The apparatus of claim 11, wherein the transaction processing unit may facilitate the financial account by coupling cash and other financial accounts to the financial account and to automatically transfer funds between such accounts.

13. The apparatus of claim 11, wherein the transaction processing unit (iii) receives a request for authorization for transfer of funds to or from another financial account, and (iv) authorizes the transaction and transfers the funds to or from the another financial account.

14. The apparatus of claim 11, wherein the processing unit assess a financial penalty against the financial account when the account balance falls below a predetermined limit.

15. The apparatus of claim 11, wherein the processing unit deposits interest into the financial account by calculating interest for a positive account balance when the account balance is above a predetermined limit.

16. The apparatus of claim 11, wherein the processing unit rejects a requested transaction amount when the transaction amount exceed the sum of the credit limit and account balance.

17. The apparatus of claim 11, wherein the credit limit may be adjusted periodically corresponding to an increase in financial account balance over time.

18. The apparatus of claim 11, wherein the credit limit may be adjusted to accommodate a purchase or withdrawal.

19. The apparatus of claim 11, wherein the processing unit (i) calculates an amount of interest due on any negative account balance, and (ii) applies the calculated amount of interest due to the financial account.

20. The apparatus of claim 11, wherein the processing unit (i) calculates the sum of the account credit limit and account balance, and (ii) compares the sum to a debit transaction amount to return an authorization result.

21. The apparatus of claim 11, wherein a sum of credit limit and financial account balance is reported to a financial account holder reflecting a total purchasing limit.

22. The apparatus of claim 11, wherein an aggregate sum or prior debits from the financial account balance and credits to the financial account balance is reported reflecting current financial account balance.
